(19) United States
(12) Patent Application Publication
(10) Pub. No.: US 2008/0042802 A1
(43) Pub. Date: Feb. 21, 2008

(54) VEHICLE COMMUNICATION MODULE

(75) Inventors: Aric Shaffer, Ypsilanti, MI (US); Perry Macneille, Lathrup Village, MI (US); Ronald Miller, Saline, MI (US); David DiMeo, Windsor (CA); Gary Strumolo, Beverly Hills, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 11/460,456

(22) Filed: Jul. 27, 2006

(51) Int. Cl. H04Q 1/30

(52) U.S. Cl. 340/7.2; 455/41.2; 307/9.1; 701/2

(57) ABSTRACT

An aspect of the invention provides a vehicle radio frequency interface module for communicating with an electronic device remote from the vehicle.

### BACKGROUND

1. Field of the Invention

The invention generally relates to a vehicle communication module.

2. Background Art

A technician may need to access diagnostic information about a vehicle in order to properly diagnose a vehicle issue. On certain vehicles, this information may only be accessed through a physical data port. The technician may need to orient the vehicle in order to gain access to the physical data port.

A technician using a wireless transponder to receive diagnostic information from the vehicle, for example, would not need to orient the vehicle in order to gain access to the physical data port. Such a technician may also be able to wirelessly upload service information to the vehicle without access to the physical data port.

A vehicle's speed while traveling over a portion of a road may indicate traffic conditions in that area. A vehicle speed of 20 miles per hour in an area that has a 50 mile an hour limit may indicate heavy traffic.

A vehicle capable of wirelessly transmitting its speed or other information to remote electronic devices would allow the vehicle to act as a data collection device.

A vehicle's ability to wirelessly communicate with its surroundings may improve the efficiency with which the vehicle is serviced and operated and allow the vehicle to collect and submit useful information.

### SUMMARY

An aspect of the invention provides a vehicle radio frequency interface module for communicating with a receiver remote from the vehicle. The module includes a network transceiver in communication with a logic processor. The network transceiver is configured to establish communication between a network within the vehicle and the logic processor. The module also includes a communication transceiver in communication with the logic processor. The communication transceiver is configured to establish communication between the module and the receiver. The module further includes a first memory in communication with the logic processor. The first memory is configured to store a message identifier. The module is configured to receive a message including at least one of action information or an identifier from the network and to selectively transmit the message to the receiver.

An aspect of the invention provides a vehicle radio frequency interface module for communicating with a transmitter remote from the vehicle. The module includes a network transceiver in communication with a logic processor. The network transceiver is configured to establish communication between a network within the vehicle and the logic processor. The module also includes a communication transceiver in communication with the logic processor. The communication transceiver is configured to establish communication between the module and the transmitter. The module further includes a first memory in communication with the logic processor. The first memory is configured to store a message identifier. The module is configured to receive a message including at least one of action information or an identifier from the transmitter remote from the vehicle and to selectively transmit the message to the network.

An aspect of the invention provides a vehicle radio frequency interface module for communicating with a transceiver remote from the vehicle. The module includes a network transceiver in communication with a logic processor. The network transceiver is configured to establish communication between a network within the vehicle and the logic processor. The module also includes a communication transceiver in communication with the logic processor. The communication transceiver is configured to establish communication between the module and the transceiver remote from the vehicle. The module further includes a first memory in communication with the logic processor. The first memory is configured to store a message identifier. The module is configured to receive a first message including at least one of first action information or a first identifier from the network and to selectively transmit the first message to the transceiver remote from the vehicle. The module is configured to receive a second message including at least one of second action information or a second identifier from the transceiver remote from the vehicle and selectively transmit the message to the network.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 shows a block diagram of an embodiment of the invention.

FIG. 2 shows a flow chart of a logic associated with the embodiment of FIG. 1.

### DETAILED DESCRIPTION

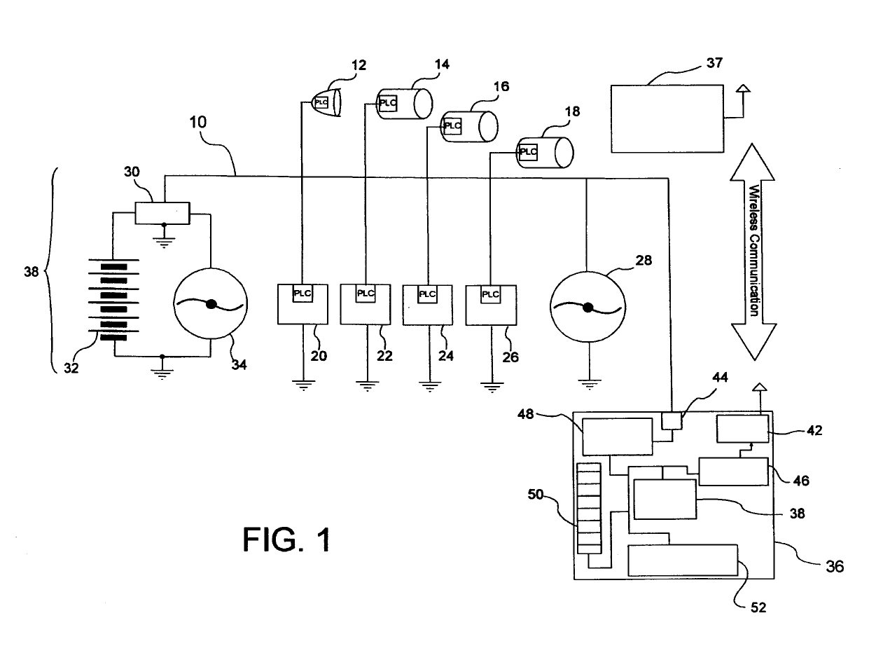

FIG. 1 shows a block diagram of a network 10, e.g., a power line communication network, a car area network (CAN), a local interconnect network (LIN), or a J1845 Network, within a hybrid gas-electric vehicle. Of course, other schematic arrangements may be implemented in a wide-variety of different automobiles to operate within the scope of the present invention.

Network 10 interconnects one or more vehicle system modules. In accordance with a preferred embodiment of the present invention, network 10 is a power line communication network including aspects, features and functionality disclosed in SAE technical paper no. 2003-01-0226 titled “Power Line Communication Implementation in Electrical Architecture” available from SAE International, 400 Commonwealth Drive, Warrendale, Pa. 15096.

As illustrated in FIG. 1, the various vehicle modules may be interconnected with the power line communication network 10 via their respective programmable logic controllers. Vehicle system modules may include a lighting control module 12, a steer by wire module 14, a brake by wire module 16, a drive by wire module 18, an engine control ECU 20, a speed control ECU 22, a pedal cluster ECU 24 and others 26. Power line communication network 10 may also interconnect a starter/drive motor 28, and a trainable radio-frequency interface module 36. Of course, other modules may be interconnected as well.

Power is provided to the power line communication network 10 by a power control system 38. Power control system 38 may include a control unit 30, a storage battery 32 and an auxiliary power unit 34.

The trainable radio-frequency interface module 36 illustrated in FIG. 1 represents a preferred embodiment of a trainable radio-frequency interface module 36. As understood by those in the art, other implementations of the trainable radio-frequency interface module 36 may be achieved within the scope of the present invention.

Trainable radio-frequency interface module 36 includes a logic processor 38. Logic processor 38 may be an ATA6814 automotive failsafe system integrated circuit available from ATMEL Corporation, 2325 Orchard Parkway, San Jose, Calif., 95131. Other processors may also be implemented, including, but not limited to, a PIC microcontroller.

Communication between the logic processor 38 and the power line communication network 10 is established by network transceiver 44. In an embodiment, the network transceiver 44 is a power line communication transceiver as described in, for example, SAE technical paper no. 2003-01-0226 titled “Power Line Communication Implementation in Electrical Architecture.” The power line communication transceiver 44 is an interface circuit for interconnecting the power line communication network 10 and the logic processor 38. In an embodiment, the logic processor 38 communicates with the power line communication transceiver 44 using the LIN protocol. The LIN protocol is well-known in the art.

Communications between the logic processor 38 and the power line communication transceiver 44 may pass through data buffer 48. In the embodiment of FIG. 1, this is to accommodate for half-duplex communication implemented by the LIN protocol, in the event the logic processor 38 and the power line communication transceiver 44 are attempting to communicate with one another at the same time.

Communication is also provided between logic processor 38 and a trainable radio-frequency transceiver 42 for establishing wireless communication between the trainable radio-frequency interface module 36 and a remote electronic device 37. Trainable radio-frequency transceiver 42 may include a transmitter such as that described in U.S. Pat. No. 6,091,343 to Dykema et al. Other radio frequency transmitters may be implemented within the scope of the present invention to communicate with the remote electronic device 37.

In the embodiment of FIG. 1, the logic processor 38 communicates with the trainable radio frequency transceiver 42. The communication can take place using, for example, the LIN protocol or a modulated radio frequency signal. Communications between the logic processor 38 and the trainable radio frequency transceiver 42 may pass through data buffer 46. This is to accommodate for half-duplex communication implemented by the LIN protocol, in the event the logic processor 38 and the trainable radio frequency transceiver 42 are attempting to communicate with one another at the same time.

The logic processor 38 is also in communication with look-up table 50. Look-up table 50 may be embodied in ferro-electric random access memory. Look-up table 50 stores packet identifiers (PIDs) for network messages that the trainable radio-frequency interface module 36 is intended to receive and process. Look-up table 50 also stores packet payload information, i.e. messages, received in packets having the appropriate PIDs. Messages are stored for subsequent transmission to the remote electronic device 37. Look-up table 50 further stores action information, associated with a PID, that determines which messages communicating over the power line communication network 10, or which messages received from the remote electronic device 37, are received and processed by the radio frequency interface module 36. Other information may also be stored in look-up table 50.

The types of messages that the radio-frequency interface module 36 may be configured to receive and/or transmit include, but are not limited to, engine status, engine fault diagnostics, fault/diagnostic information from other vehicle systems (e.g., vehicle drive system, braking system, steering system, etc.), vehicle maintenance information, garage door open/close signals, and administrative operations.

Vehicle-as-a-probe messages may also be generated on the vehicle and communicated over the power line communication network 10 to the radio-frequency interface module 36 for communication to the remote electronic device 37. For example, the activation of windshield wipers may cause a “wipers on” message to be communicated over the power line communication network 10. This message may be received by the radio-frequency interface module 36 and communicated to a roadside radio-frequency transmitter configured to relay such vehicle-as-a-probe information to appropriate destinations, such as a weather center. In this example, if enough “wipers on” messages are received at the weather center from different vehicles in a particular area, the weather center may deduce that it is raining in that area. The vehicle-as-a-probe information may be used to increase the quality of weather reports. Similarly, “brakes on” messages may be transmitted to a traffic center to imply traffic congestion in a particular area.

Communication between the radio-frequency interface module 36 and the remote electronic device 37 is initiated by a triggering event that is communicated to the radio-frequency interface module 36 via action information included in a message. A triggering event may be generated from within the vehicle (e.g., by the push of a button, etc.), or remote from the vehicle.

Remotely-generated triggering messages are communicated to the radio-frequency transceiver 42, and then to the logic processor 38. The logic processor 38 accesses the look-up table 50 to determine whether the received message is a triggering message.

A variety of different triggering messages may seek a variety of different information stored by or within the radio frequency interface module 36. For example, an “open garage door” message may be generated from within the vehicle, communicated to the radio frequency interface module 36, and cause the outbound transmission of a “door open” signal to a remote radio-frequency transmitter located within a garage door opener. Similarly, a “get diagnostic codes” triggering message may be sent to the radio frequency interface module 36 from a remote transmitter located at a repair facility. The radio frequency interface module 36 will, in turn, act on this triggering message by sending an outbound transmission that includes some or all vehicle diagnostic codes that were previously saved by or within the radio frequency interface module 36.

Radio frequency interface module 36 may also include a radio-frequency code memory 52. The code memory 52 is non-volatile. Code memory 52 may store program instructions for the logic processor 38. Code memory 52 may store PIDs that allow for the periodic refreshing of the look-up table 50. Example PID categories may include, but are not limited to engine status, engine fault diagnostics, fault/diagnostic information from other vehicle systems (e.g., vehicle drive system, braking system, steering system, etc.), vehicle maintenance information, garage door open/close signals, and administrative operations.

A variety of operations may be executed with the radio-frequency interface module 36 by appropriate triggering messages. As described above, if messages are received from the power line communication network 10 that have an appropriate PID and associated action information within look-up table 50, the message is pushed to the radio-frequency transceiver 42 for communication to the remote electronic device 37.

Another operation includes updating information within look-up table 50. For example, PID information may be added, removed, or changed.

Another operation that may be implemented with the radio-frequency interface module 36 includes a firmware storage or update operation. This operation receives firmware for a vehicle system from a remote electronic device 37, and communicates that firmware over power line communication network 10 with the appropriate PID to achieve a firmware update for the target vehicle system.

Yet another operation that may be implemented with the radio-frequency interface module 36 includes “training” the radio-frequency transceiver 42. This operation enables the transceiver 42 to learn the carrier frequency, modulation scheme, or data code of a received radio frequency signal. This feature is described in U.S. Pat. No. 6,091,343 to Dykema et al.

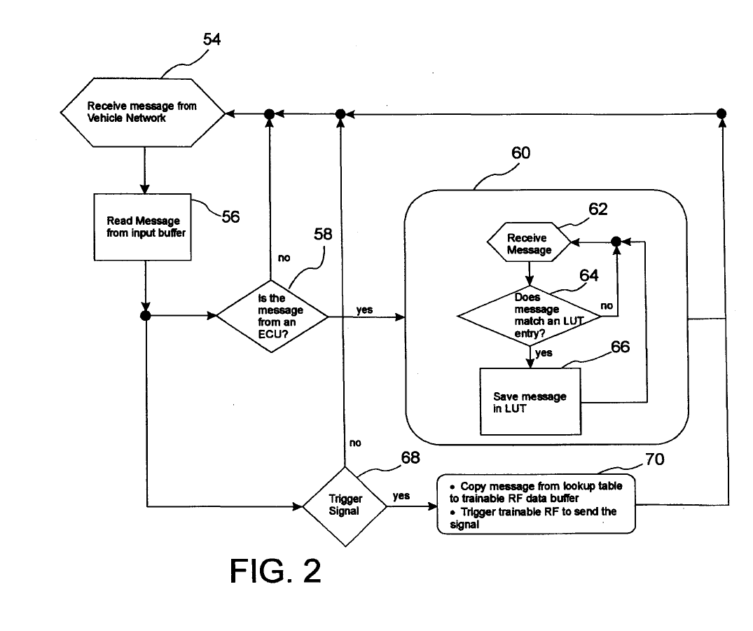

FIG. 2 shows a flow chart of a logic associated with the embodiment of FIG. 1.

At step 54, a message is received from the power line communication network 10.

At step 56, the message is read from the first data buffer 48.

At step 58, it is determined whether the message is from a vehicle system module. If no, the logic returns to step 54. If yes, the logic enters thread 60.

At step 62, the message is received.

At step 64, it is determined whether the message's PID matches an entry in the look-up table 50. If no, the logic returns to step 62. If yes, at step 66, the message is saved in look-up table 50.

At step 68, it is determined whether the message is a trigger signal based on any action information. If no, the logic returns to step 54. If yes, at step 70, the message is copied from the look-up table 50 and sent by the trainable radio-frequency transceiver 42.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A vehicle radio frequency interface module for communicating with a receiver remote from the vehicle comprising:
a network transceiver in communication with a logic processor, the network transceiver configured to establish communication between a network within the vehicle and the logic processor;
a communication transceiver in communication with the logic processor, the communication transceiver configured to establish communication between the module and the receiver;
a first memory in communication with the logic processor, the first memory configured to store a message identifier; and
wherein the module is configured to receive a message including at least one of action information or an identifier from the network and to selectively transmit the message to the receiver.

2. The module of claim 1 wherein the module selectively transmits the message based on the action information.

3. The module of claim 1 wherein the first memory includes a look-up table and wherein the message identifier is stored in the look-up table.

4. The module of claim 1 wherein the message is stored in the first memory prior to being transmitted to the receiver.

5. The module of claim 1 further comprising a first data buffer in communication with the logic processor and network transceiver, the first data buffer configured to temporarily store information transmitted between the logic processor and network transceiver if the logic processor and network transceiver are attempting to communicate simultaneously.

6. The module of claim 1 wherein the message includes information about the vehicle.

7. The module of claim 1 wherein the message includes command information for an electronic device remote from the vehicle.

8. The module of claim 1 further comprising a second memory configured to store program instructions for the logic processor.

9. The module of claim 1 further comprising a second data buffer in communication with the logic processor and the communication transceiver, the second data buffer configured to temporarily store information transmitted between the logic processor and communication transceiver if the logic processor and communication transceiver are attempting to communicate simultaneously.

10. A vehicle radio frequency interface module for communicating with a transmitter remote from the vehicle comprising:
a network transceiver in communication with a logic processor, the network transceiver configured to establish communication between a network within the vehicle and the logic processor;
a communication transceiver in communication with the logic processor, the communication transceiver configured to establish communication between the module and the transmitter;
a first memory in communication with the logic processor, the first memory configured to store a message identifier; and
wherein the module is configured to receive a message including at least one of action information or an identifier from the transmitter remote from the vehicle and to selectively transmit the message to the network.

11. The module of claim 10 wherein the module selectively transmits the message based on the action information.

12. The module of claim 10 wherein the first memory includes a look-up table and wherein the message identifier is stored in the look-up table.

13. The module of claim 10 wherein the message is stored in the first memory prior to being transmitted to the network.

14. The module of claim 10 further comprising a first data buffer in communication with the logic processor and network transceiver, the first data buffer configured to temporarily store information transmitted between the logic processor and network transceiver if the logic processor and network transceiver are attempting to communicate simultaneously.

15. The module of claim 10 wherein the message includes firmware for a vehicle system.

16. The module of claim 10 further comprising a second data buffer in communication with the logic processor and the communication transceiver, the second data buffer configured to temporarily store information transmitted between the logic processor and the communication transceiver if the logic processor and the communication transceiver are attempting to communicate simultaneously.

17. A vehicle radio frequency interface module for communicating with a transceiver remote from the vehicle comprising:
a network transceiver in communication with a logic processor, the network transceiver configured to establish communication between a network within the vehicle and the logic processor;
a communication transceiver in communication with the logic processor, the communication transceiver configured to establish communication between the module and the transceiver remote from the vehicle;
a first memory in communication with the logic processor, the first memory configured to store a message identifier;
wherein the module is configured to receive a first message including at least one of first action information or a first identifier from the network and to selectively transmit the first message to the transceiver remote from the vehicle; and
wherein the module is configured to receive a second message including at least one of second action information or a second identifier from the transceiver remote from the vehicle and selectively transmit the message to the network.

18. The module of claim 17 wherein the module selectively transmits the first message based on the first action information.

19. The module of claim 17 wherein the first message includes information about the vehicle.

20. The module of claim 17 wherein the first message includes command information for an electronic device remote from the vehicle.
